(19) United States
(12) Patent Application Publication
(10) Pub. No.: US 2024/0257160 A1
(43) Pub. Date: Aug. 1, 2024

(54) CLASSIFYING NODES OR EDGES OF GRAPHS BASED ON NODE EMBEDDINGS AND EDGE EMBEDDINGS

(71) Applicant: Salesforce, Inc., San Francisco, CA (US)

(72) Inventors: Akash Singh, Gurgaon (IN); Rajdeep Dua, Hyderabad (IN)

(21) Appl. No.: 18/138,962

(22) Filed: Apr. 25, 2023

(30) Foreign Application Priority Data
Jan. 30, 2023 (IN) 202341005968
Jan. 30, 2023 (IN) 202341005985

(51) Int. Cl. G06Q 30/0201; G06Q 30/018

(52) U.S. Cl. CPC G06Q 30/0201; G06Q 30/0185

(57) ABSTRACT

A method or a system for predicting a likelihood of an occurrence of a transaction. The system accesses a graph including multiple nodes and multiple edges linking the nodes. The multiple nodes include a first type of nodes representing a first type of entities an a second type of nodes representing a second type of entities. The system extract a set of node features for each node, and a set of edge features for each edge. For an edge connecting a first node of the first type and a second node of the second type, the system generates a set of edge embeddings based in part on the node features and edge features, and computes a score based in part on the set of edge embeddings. The score indicates a likelihood of an occurrence of a transaction between the first node and the second node.

### RELATED APPLICATION

This application claims the right of priority based on India Provisional Patent Application Serial No. 202341005985, entitled “Classifying Nodes or Edges of Graphs Based on Node Embeddings and Edge Embeddings”, filed Jan. 30, 2023, and India Provisional Patent Application Serial No. 202341005968, entitled “Neural Network for Generating Both Node Embeddings and Edge Embeddings for Graphs”, filed Jan. 30, 2023, the content of each of the foregoing are incorporated herein by reference in its entirety.

### BACKGROUND

### Field of Art

This disclosure generally relates to machine learning classification, more specifically relates to training a neural network to generate node embeddings and edge embeddings for classifying a node or edge of a graph.

### Description of the Related Art

Neural networks, also known as artificial neural networks (ANNs), are a subset of machine learning. Their name and structure are inspired by the human brain, mimicking the way that biological neurons signal to one another. ANNs often have multiple layers, including an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network. Neural networks rely on training data to learn and improved their accuracy over time. Once the neural network are trained, they are powerful tools in artificial intelligence, allowing people to classify and cluster data at a high velocity and accuracy.

Many real world datasets can be represented as graphs. Representing data as graphs provides a method of expressing the different ways participating entities can be connected to and interact with each other. Some neural networks are developed to operate on graph data. Such neural networks are called graph neural networks (GNNs).

### BRIEF DESCRIPTION OF DRAWINGS

FIG. 1 is an example graph generated based on a lead management system, in accordance with one or more embodiments.

FIG. 2 is a block diagram illustrating an example neural network system, in accordance with one or more embodiments.

FIG. 3A illustrates an example neural network having K layers, in accordance with one or more embodiments.

FIG. 3B illustrates an example kth layer of the neural network in FIG. 3A, in accordance with one or more embodiments.

FIG. 3C illustrates an example network that may follow the neural network of FIG. 3A configured to perform node classification, in accordance with one or more embodiments.

FIG. 3D illustrates an example network that may follow the neural network of FIG. 3A configured to perform edge classification, in accordance with one or more embodiments.

FIG. 4 is a flowchart of an example method of predicting a likelihood of an occurrence of a transaction between nodes in a graph, in accordance with one or more embodiments.

FIG. 5 is a flowchart of an example method of visualizing a graph, in accordance with one or more embodiments.

FIG. 6 is a flowchart of an example method of classifying a node in a graph based in part on information related to related nodes and edges in the graph, in accordance with one or more embodiments.

FIG. 7 is a block diagram illustrating the architecture of a typical computer system for use in the system of FIG. 2, in accordance with one or more embodiments.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements.

### DETAILED DESCRIPTION

Existing graph neural networks (GNNs) have some limitations. First, most of the GNNs are limited to using node features to calculate node embeddings, which are then used in downstream machine-learning (ML) models. However, in many scenarios, important information is present as edge features, which are not utilized by existing graph neural networks. Further, most GNNs only work with single type of nodes and edges. In complex business processes and domains, there are different types of entities interacting with each other in many different ways, which cannot be captured by existing GNNs.

For example, in many data systems, a lead is a prospective customer represented by an individual and/or a company. Some lead management systems allow customers to score their leads and prioritize the leads based on their scores. Such a lead scoring system may use a machine learning (ML) model to generate lead scores. The output score indicates the likelihood of lead conversion based on historical data on leads and conversions. Such an ML model is often based on tabular data, including fields as features, such as industry, state, annual revenue, lead source, lead status, department, job rank, etc. Even though these features are relevant to a likelihood of lead conversion, such an ML model, operating on tabular data, is limited in the way that each row of data is independent of all others, because the real world relationships include complex connections and interactions between companies, customer, and salespersons. These connections and interactions have a bearing on lead conversion but cannot be captured by an ML model operating on tabular data.

Embodiments described herein solve the above-described problems by implementing a novel neural network system (hereinafter also referred to as “the system”). To capture the real-world connections and interactions between different entities, the system described herein models data as a heterogeneous knowledge graph. Nodes in the graph represent entities. There are different types of entities, represented by different types of nodes. The edges in the graph represent interactions and relationships between the nodes. For each node, a set of node features is determined based on information associated with the node. For each edge, a set of edge features are determined based on information associated with the edge.

For any given edge that connects a first node of a first type and a second node of a second type, the system generates a first set of node embeddings for the first node, and generate a second set of node embeddings for the second node based in part on the node features and the edge features. The system also generates a set of edge embeddings for the edge based in part on the first set of node embeddings, the second set of node embeddings, and the set of edge features. The system then computes a score based in part on the set of edge embeddings. The score indicates a likelihood of an occurrence of a transaction between the first node and the second node.

For example, the entities may include (but are not limited to) salespersons and leads. The edges linking the nodes represent interactions and relationships between the nodes. For example, the edges include an edge that links a first node corresponding to a lead and a second node corresponding to a salesperson. The set of edge embeddings of the edge may be used to predict a likelihood of whether the lead is to be converted to the customer by the salesperson.

### Example Graph

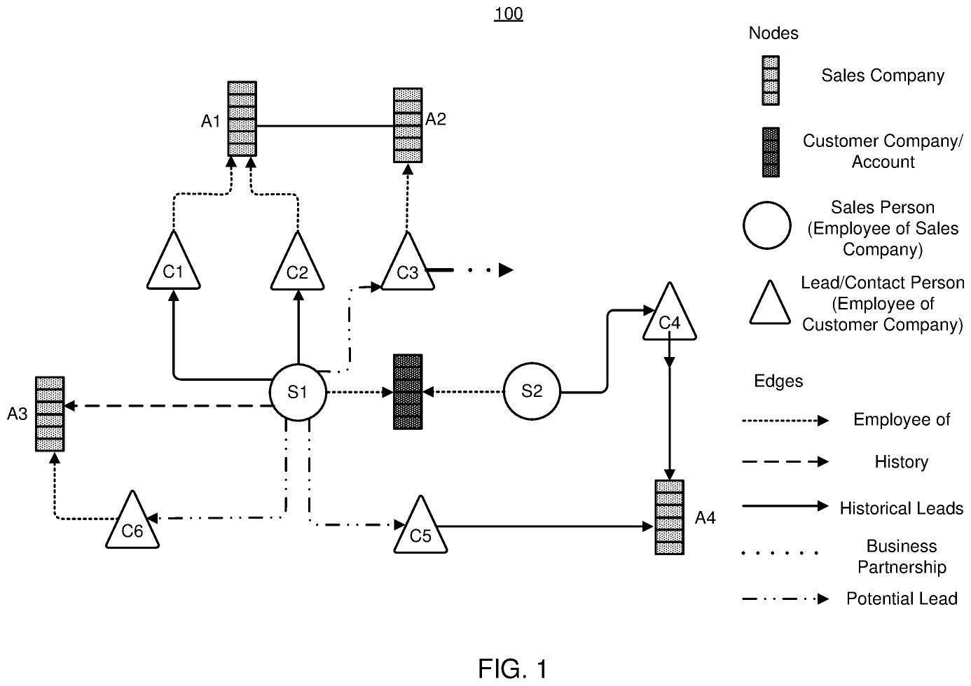

FIG. 1 is an example graph 100 generated based on a lead management system. The graph 100 includes a plurality of nodes and a plurality of edges linking the plurality of nodes. As illustrated, the plurality of nodes corresponds to a plurality of different types of entities, including sales companies, customer companies/accounts, sales persons, and leads/contact persons. A sales company is a company that uses lead scoring to rank potential leads. A salesperson is a salesperson employed by the sales company. An account/customer company is a customer or potential customer of the sales company. A lead/contact person is an employee of an account company, who is a lead for a salesperson and contacted by the salesperson. The lead/contact person is a decision maker who has the authority to decide whether to make a deal with a sales company that the salesperson represents.

The edges in the graph 100 represent interactions and relationships between the nodes. The interactions and relationships may include (but are not limited to) an employee-employer relationship, a history between two entities, a business partnership, a historical lead, a potential lead, a department, a job, etc. For example, an edge representing an employee-employer relationship linking a salesperson and a sales company indicates that the salesperson is an employee of the sales company; an edge representing a history of two entities linking the salesperson and a second sales company indicates that the salesperson is a former employee of the second sales company; an edge representing a business partnership of two entities linking two companies indicates that the two companies have a business association; an edge representing a historical lead linking an account company and a sales company with a conversion label 1 or 0 indicates the account company has been converted or not converted; an edge representing a potential lead linking an account company and a sales company indicates the account company is to be scored by the model for predicting a conversion score.

Business networking and relationships are crucial in sales. For example, the edge linking S1 and C3 indicates that salesperson S1 does not have any history with lead/contact C3 or Account A2, while edge linking A1 and A2 indicates that company A2 has a business alliance with A1, which increases the chance of converting the lead C3 by S1. The edge linking S1 and C4 indicates that S1 has a history with Account A3, which also increases the chance of converting the lead C3 by S1. Further, there is no edge between C5 and A4, but S2 (who is S1's colleague) has converted lead C4, who works at A4. Thus, S1 can utilize S2's knowledge and contacts to convert C5.

However, these relationships cannot be captured in a tabular dataset, nor can they be captured by existing neural network models or GNN models. Embodiments described herein use a novel neural network system to capture these connections. The system is configured to model nodes and their complex relationships in a heterogenous graph. The system is able to process node/entity features, so that the system can make use of entity features or fields. The system is also able to process edge/relationship features, which provide information on the nature and characteristics of the connection between nodes.

The system described herein provides many advantages compared to existing neural networks or GNNs. First, it is advantageous for the system to consider both node features and edge features in scoring. This allows the system to exploit edge connections while making predictions, i.e., making use of graph structure and local topology. For example, the system is able to train an edge classifier to output lead scores for a given edge. It is also advantageous for the system to be able to handle disparate nodes and edges that represent different entity types and relationships, which is often the case in real-life scenarios. Additionally, the system is also able to handle evolving graphs. In particular, the system is able to score new nodes and edges without having to retrain the model. The system is also able to handle new sub-graphs, such that, the system is generalizable to new graphs/subgraphs with similar properties. This is critical as lead data is evolving with new contacts and customers being added continuously.

### Overall System Environment

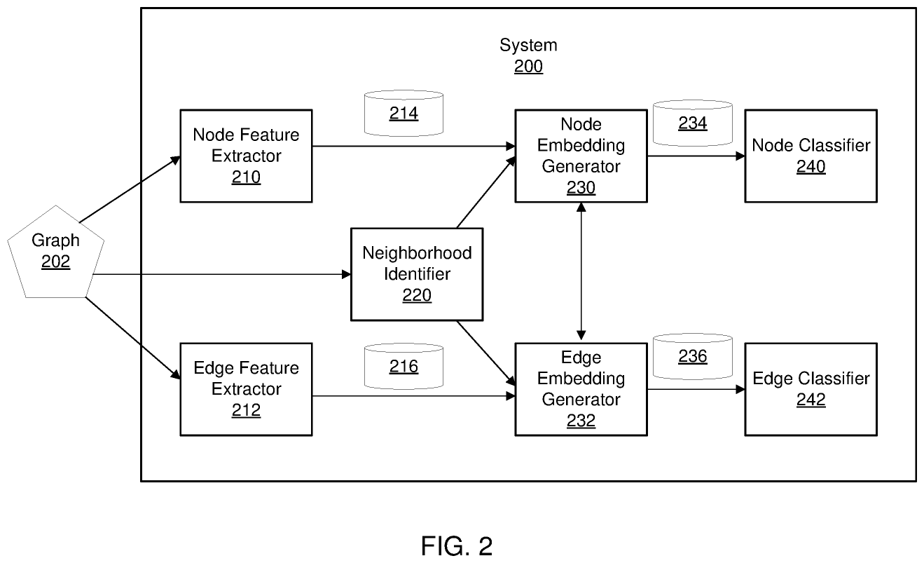

FIG. 2 is a block diagram illustrating an example system 200, in accordance with one or more embodiments. The system 200 includes a node feature extractor 210, an edge feature extractor 212, a neighborhood identifier 220, a node embedding generator 230, an edge embedding generator 232, a node classifier 240, and/or an edge classifier 242. In some embodiments, there may be more or fewer components in system 200. Alternatively, or in addition, functions of different components may be combined or redistributed. The system 200 is configured to receive a graph 202, and use data contained in graph 202 to train the node embedding generator 230, the edge embedding generator 232, the node classifier 240, and/or the edge classifier 242.

Graph 202 is denoted as [symbol] =(V, ε), where V is a set of all vertices or nodes and ε is a set of all edges. An edge is denoted as (u, v), where u∈V, and v∈V. The node feature extractor 210 is configured to extract a set of node features 214 for each node in V based on information associated with the node. The edge feature extractor 212 is configured to extract a set of edge features 216 for each edge in E based on information associated with the edge.

The neighborhood identifier 220 is configured to identify a subset of nodes that are in a neighborhood of any given node. For example, for a target node, the neighborhood identifier 220 identifies a subset of nodes that are in a neighborhood of the target node. The neighborhood may be defined to be within a number of edges from the target node. For example, if the number of edges is 2, only the nodes within two edges from the target node are in the neighborhood. In some embodiments, the subset of nodes is sampled from nodes in the neighborhood. The node embedding generator 230 is configured to obtain node features 214 of the subset of nodes, and determine a node embedding 234 for the target node based in part on the node features 214 of the subset of nodes that are in the neighborhood of the target node.

For a target edge (u, v), the neighborhood identifier 220 identifies a subset of nodes that are in a neighborhood of node u, and a subset of nodes that are in a neighborhood of node v. The node embedding generator 230 is configured to determine a set of node embedding for node v, and a set of node embedding for node u. The edge embedding generator 232 is configured to obtain edge features 216 of target edge (u, v), and determine an edge embedding 234 for the target edge (u, v) based in part on the edge features 216 of the target edge (u, v), and the set of node embeddings for node u, and the set of node embeddings for node v.

The node embeddings 234 are input to the node classifier 240. The node classifier 240 is trained to receive a set of node embeddings for any given node to output a classification, which may be a score or a binary output. For example, the node classifier 242 may be a fraud detection model. For a given node representing a merchant, the node classifier 242 is trained to predict a likelihood of whether the merchant is fraudulent before a transaction is made. The nodes in graph G are customers and merchants. The customers purchase products and services from merchants. Node features may include merchant features, such as industry, geo information, number of transactions in a recent time period (e.g., 30 days), a total amount of transactions, a number of customers transacted with a merchant, etc. The edges may represent transactions performed between merchants and customers in a recent short window (e.g., 1 day or 1 week). Edge features may include time of transaction, an amount of transaction, a type of transaction, a fraud score of transaction, etc. The node classifier 240 is trained to predict whether a merchant is fraudulent.

The edge embeddings 236 are input to the node classifier 242. The edge classifier 242 is trained to receive a set of edge embeddings for any given node to output a classification, which may be a score or a binary output. For example, the edge classifier 242 may be a merchant recommendation model. For any given edge representing a customer-merchant pair, the edge classifier 242 is trained to predict a likelihood of whether the customer is to complete a transaction with the merchant. The nodes in graph G are customers and merchants. The customers purchase products and services from merchants. The edges denote transactions between merchants and customers. Node features may include customer features, such as age, location, number of transactions, etc., and merchant features, such as type, industry, category, etc. Edge features may include transaction features such as an amount of a transaction, a type of transaction (e.g., domestic, cross border), etc. The edge classifier 242 is trained to predict whether a customer will complete a transaction with a merchant.

In embodiments, the node embedding generator 230, the edge embedding generator 232, the node classifier 240, and/or edge classifier 242 are implemented in a neural network.

### Example Neural Network

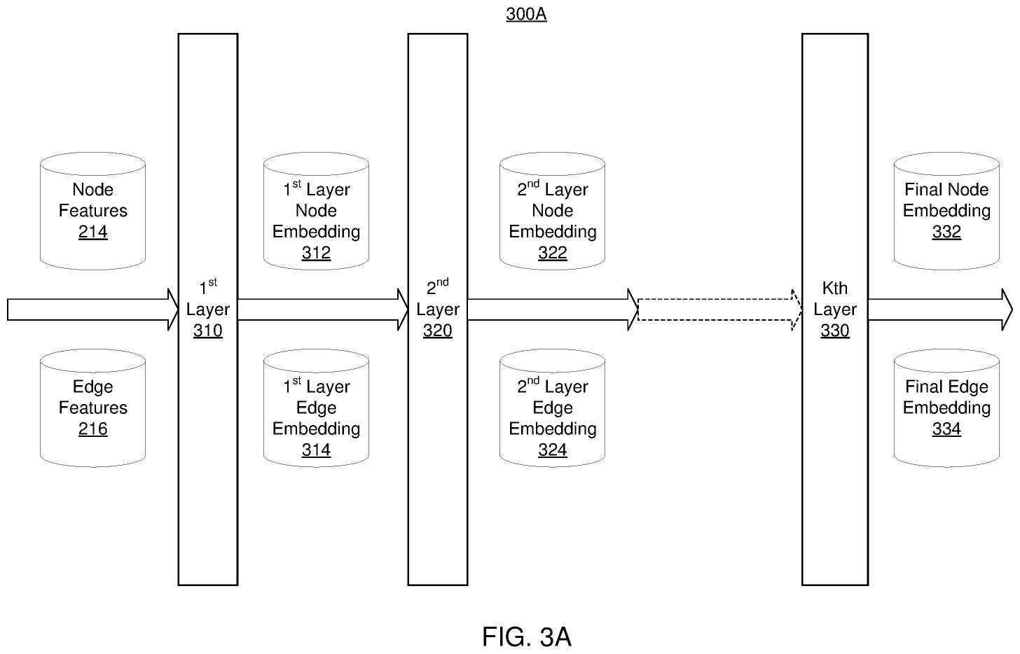

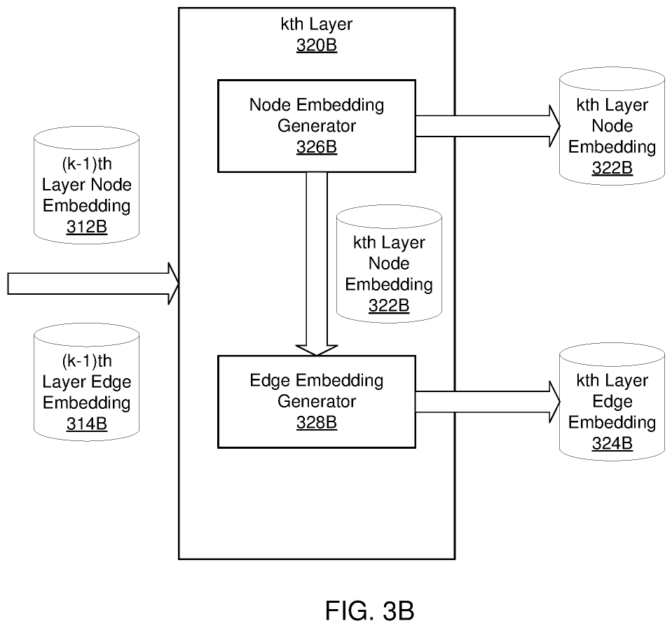

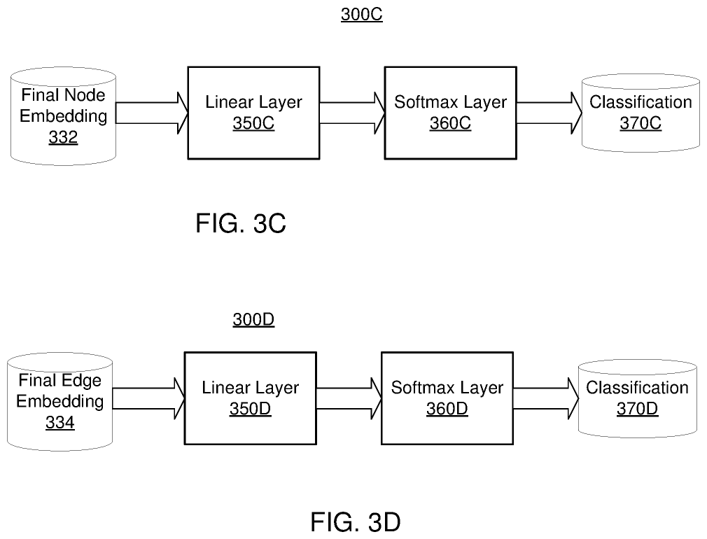

FIGS. 3A-3D illustrate example embodiments of a neural network that is trained to generate node embeddings and edge embeddings, and/or perform classifications based on the node embeddings or edge embeddings.

FIG. 3A illustrates an example neural network 300A having K layers. Search depth or number of layers in the network 300A is denoted by K>1. The individual layers are numbered from 1 to K. Weight matrices are denoted as W_{node}^{k} ∀K∈{1, . . . , K}, which are per layer/depth weights that are used to transfer information from node embeddings at one layer of network 300A to the node embeddings at a next layer. A neighborhood function is denoted as N(v), which samples neighboring nodes of node v. A number of neighborhood nodes that are to be sampled is decided by constants S₁, . . . , S_{K}, ∀K∈{1, . . . , K}. K node aggregator functions are denoted as AggNodeₖ∀k∈{1, . . . , K}, which are used to aggregate nodes. K edge aggregator functions are denoted as AggEdgeₖ∀k∈{1, . . . , K}, which are used to aggregate edges. k refers to a current layer/depth of the network, and v denotes a current node being processed. Node features are denoted as {xᵥ, ∀v∈V}. Edge features are denoted as {xᵤᵥ, ∀(u, v)∈E}.

The neural network 300A takes node features 214, and edge features 216 as input, and transforms them into node embeddings and edge embeddings. This process is iterative with one iteration for each layer in K layers of the network 300A. At each iteration, node/edge embeddings, are updated by aggregating the nodes/edges in a local neighborhood. As the process iterates, the embeddings gain more information from the graph structure.

In some embodiments, different node types may have different numbers of features, and all node features may be set to be of a same fixed length, e.g., by zero padding. During training, masking may be used to remove some of zero padded positions from gradient updates. In addition, an indicator variable (also referred to as “a first indicator variable”) may be used to define a node/entity type. This indicator variable allows the model to process different node types and preserve node type information in the node embeddings.

Similarly, in some embodiments, different edge types may have different numbers of features, and all edge features may be set to be a same fixed length, e.g., by zero padding. Masking may also be used to remove some of the zero-padded positions from gradient updates. In addition, an indicator variable (also referred to as “a second indicator variable”) may be used to define an edge/relationship type. This indicator variable allows the model to process different edge types and preserve edge type information in the edge embeddings.

First, the node embeddings, hᵥ⁰, are initialized from the node features. This process is denoted in Equation (1) below.

$${h}_{v}^{0} ← {x}_{v} , ∀ v ∈ V \qquad ( 1 )$$

Further, the edge embeddings are initialized using the edge features. This process is denoted in Equation (2) below:

$${e}_{u v}^{0} ← {r}_{uv} , ∀ ( u , v ) ∈ ℰ \qquad ( 2 )$$

For k=1, . . . K, for v∈V, a set of processes are performed. The set of processes is denoted by Equations (3)-(5) below. The multiple steps include a process of computing an aggregate vector representation h_{N(v)}^{k} of the neighborhood nodes of v at depth k. In embodiments, this is performed by applying AggNodeₖ function to the vector representation of the neighboring node hᵤ^{k-1} at depth k−1. The neighboring nodes are provided by N(v). This process is denoted by Equation (3) below.

$${h}_{N ( v )}^{k} ← Agg {Node}_{k} ( \{ {h}_{u}^{k - 1} , ∀ u ∈ N ( v ) \} ) \qquad ( 3 )$$

The set of processes further includes a process of computing an aggregate vector representation of the neighboring edges of v at depth k. In embodiments, this is performed by applying AggEdgeₖ function to the vector representation of the neighboring edge (ex-1) at depth k−1. This process is denoted by Equation (4) below.

$${e}_{N ( v )}^{k} ← Agg {Edge}_{k} ( \{ {e}_{u v}^{k - 1} , ∀ ( u , v ) ∈ ℰ : u ∈ N ( v ) \} ) \qquad ( 4 )$$

The set of processes further includes a process of computing the depth k embedding hᵥ^{k} of v. In embodiments, this is performed by concatenating the node's depth k−1 representation hᵥ^{k-1} with the aggregated neighborhood node vector h_{N(v)}^{k}, and the aggregated neighborhood edge vector e_{N(v)}^{k} The concatenated vector is passed through a fully connected neural network layer with nonlinear activation σ, and depth k weighs W_{node}^{k}.This process is denoted by equation (5) below.

$${h}_{v}^{k} ← σ ( {W}_{n o d e}^{k} \cdot CONCAT ( {h}_{v}^{k - 1} , {h}_{N ( v )}^{k} , {e}_{N ( v )}^{k} ) ) \qquad ( 5 )$$

Further, for (u, v)∈E, the depth k embedding of edge (u, v) is computed. In embodiments, this is performed by concatenating the edge embeddings at depth k−1, with the update depth k node embeddings of nodes u and v. The concatenated vector is passed through a fully connected neural network layer with nonlinear activation σ and depth k weights W_{edge}^{k}. This process is denoted by equation (6) below.

$${e}_{u v}^{k} ← σ ( {W}_{e d g e}^{k} \cdot CONCAT ( {e}_{u v}^{k - 1} , {h}_{u}^{k} , {h}_{v}^{k} ) ) \qquad ( 6 )$$

In some embodiments, the node embeddings and/or edge embeddings are normalized. Equation (7) below denotes a process of normalizing the node embeddings.

$${h}_{v}^{k} ← \frac{{h}_{v}^{k}}{{‖ {h}_{v}^{k} ‖}_{2}} , ∀ v ∈ V \qquad ( 7 )$$

Equation (8) below denotes a process of normalizing the edge embeddings.

$${e}_{u v}^{k} ← \frac{{e}_{u v}^{k}}{{‖ {e}_{u v}^{k} ‖}_{2}} , ∀ ( u , v ) ∈ ℰ \qquad ( 8 )$$

The above-described process repeats K times before final node and/or edge embeddings are generated. For example, when k=1, for a given node v, the first layer 310 receives node features 214 (which can also be deemed as 0^{th} layer embeddings) as input. The first layer 310 determines 1^{st} layer node embeddings 312 for node v based on Equations (3)-(5) and/or (7). For a given edge (u, v), the first layer 310 receives node features 214 for nodes u and v, and edge features 216 for edge (u, v) (which can also be deemed as 0^{th} layer embeddings) as input. The first layer 310 determines 1^{st} layer node embeddings 314 for nodes u and v based on Equations (3)-(5) and/or (7). The first layer 310 then determines 1^{st} layer edge embeddings 314 for edge (u, v) based on Equations (6) and/or (8), which uses the 1^{st} layer node embeddings for nodes u and v, and edge features for edge (u, v).

As another example, when k=2, for a given node v, the second layer 320 receives 1^{st} layer node embeddings 312 for node v as input. The second layer 320 determines 2^{nd} layer node embeddings 322 for node v based on Equations (3)-(5) and/or (7). For a given edge (u, v), the second layer 310 receives 1^{st} layer node embeddings 312 for node u and v, and 1^{st} layer edge embedding 314 for edge (u, v). The second layer 320 determines 2^{nd} layer node embeddings 322 for nodes u and v based on Equations (3)-(5) and/or (7). The second layer 320 also determines 2^{nd} layer then determines 2^{nd} layer edge embeddings 324 for edge (u, v) based on Equation (6) and/or (8), which uses 2^{nd} layer node embeddings for nodes u and v, and 1^{st} layer edge embedding for edge (u, v).

For a given k (where 1≤k≤K), this process is further illustrated in FIG. 3B. FIG. 3B illustrates a kth layer 320B of the neural network 300A of FIG. 3A. As illustrated, the kth layer 320B receives node embeddings 312B and edge embeddings 314B output from the previous layer, i.e., (k−1)th layer, and determines kth layer node embedding 322B and edge embeddings 324B based on the (k−1)th layer node embeddings 312B and edge embeddings 314B.

In particular, the kth layer 320B includes a node embedding generator 326B that determines kth layer node embeddings 322B and edge embeddings 324B based on the (k−1)th layer node embedding 312B and edge embeddings 314B. For example, the node embedding generator 326B may apply Equations (3)-(5) and/or (7) to generate the kth layer node embeddings 322B. The edge embedding generator 328B may apply Equations (6) and/or (8) to generate the kth layer edge embeddings 324B.

This process repeats K times, until the Kth layer 330 determines Kth layer node embedding for v, and/or Kth layer edge embedding for edge (u, v), which are also referred to as final node embeddings and final edge embeddings. Equation (9) below denotes final node embeddings.

$${z}_{v} ← {h}_{v}^{K} , ∀ v ∈ V \qquad ( 9 )$$

Equation (10) below denotes final edge embeddings.

$${q}_{u v} ← {e}_{uv}^{K} , ∀ ( u , v ) ∈ ℰ \qquad ( 10 )$$

Note, as shown in Equation (5), at each layer, the updated node embeddings is computed based on node embeddings from a previous layer, node neighborhood vector, and edge neighborhood vector. Similar to Equation (5), in Equation (6), the edge embedding is updated by concatenating the edge embedding from the previous layer, with the updated embeddings of two nodes in the edge. This sequence of updates mixes the node and edge features together such that final edge embeddings and/or node embeddings encode relevant information from both edges and nodes. As such, the final classification layer is able to use either edge embeddings and/or node embeddings without loss of information, allowing the model to be used for both edge classification and node classification.

As discussed above, a neighborhood is denoted by N(v), which determines a set of nodes that are in a neighborhood of v. For depth/layer k, a number of neighbors to be sampled is denoted as Sk. In some embodiments, probabilistic Breadth First Search (BFS) is used to identify the neighborhood, where nodes at a same search-depth are picked uniformly at random. If the number of neighbors for a node is less than Sₖ, constant all Is vectors may be used.

Once the neighboring nodes of a node are determined, a single vector representation of the neighborhood may be computed. In embodiments, this is achieved through node and edge aggregation functions. The node and edge aggregation functions may be trained or learned during the model training. The aggregation functions are the chief reason the graph is inductive and can process new unseen nodes. Once the functions are learned, they can be applied to any new nodes added to the graph.

The node aggregation function AggNodeₖ is generated by passing each neighbor's vector through a single layer neural network. This gives a set of vectors, with each element being an intermediate representation of the corresponding neighborhood node, which can then be reduced to a single vector by a pooling operation. In embodiments, max pooling is used. This process is denoted by Equation (11) below.

$${AggNode}_{k} = maxpool ( \{ σ ( {W}_{aggn} {h}_{u}^{k} + b ) , ∀ u ∈ N ( v ) \} ) \qquad ( 11 )$$

Similarly, the edge aggregation function AggEdgeₖ may also be generated by computing a single vector representation of the edges in the neighborhood of v. In embodiments, max pooling is used. This process is denoted by Equation (12) below.

$${AggEdge}_{k} = maxpool ( \{ σ ( {W}_{agge} {e}_{uv}^{k} + b ) , ∀ ( u , v ) ∈ ℰ : v ∈ N ( v ) \} ) \qquad ( 12 )$$

In some embodiments, the neural network also includes a classifier head, consisting of a linear layer, and a softmax layer, which are trained end to end as a binary classifier to perform either node classification or edge classification. FIG. 3C illustrates an example network 300C that may follow the neural network 300A configured to perform node classification. Network 300C includes a classifier head 340C configured to receive the final node embedding 332 determined by the neural network 300A. The final node embedding 332 is passed through a linear layer 350C and a softmax layer 360C to output a classification score 370C.

FIG. 3D illustrates an example network 300D that may follow the neural network 300A configured to perform edge classification. Network 300D includes a classifier head configured to receive the final edge embedding 334 determined by the neural network 300A. The final edge embedding 334 is passed through a linear layer 350D and a softmax layer 360D to output a classification score 370D. In the example of lead scoring, historical leads with conversion labels may be used as target variables. A loss function used is cross entropy. Edge classification is performed by passing the edge embeddings (qᵤᵥ) through a linear layer with softmax layer at the top as shown in Equations (13)-(14) below.

$$\overline{{y}_{uv}} = softmax ( {q}_{uv}^{T} {W}_{classifier} ) \qquad ( 13 )$$

$$L = - {\sum }_{( uv ) ∈ ℰ} {y}_{uv} log ( \overline{{y}_{uv}} ) + ( 1 + {y}_{uv} ) log ( 1 - \overline{{y}_{uv}} ) \qquad ( 14 )$$

Similarly, node classification can also be performed by using the node embeddings and passing through linear with softmax layer at the top.

The lead scoring example, merchant recommendation model, and fraud detection model are merely example use cases to introduce and explain the problem The model described herein can be applied to any domain and use case where data can be represented as a graph where different nodes are connected to each other with different ways, and both node features and edge features contain useful information.

### Example Process for Predicting a Likelihood of an Occurrence of a Transaction Between Nodes in a Graph

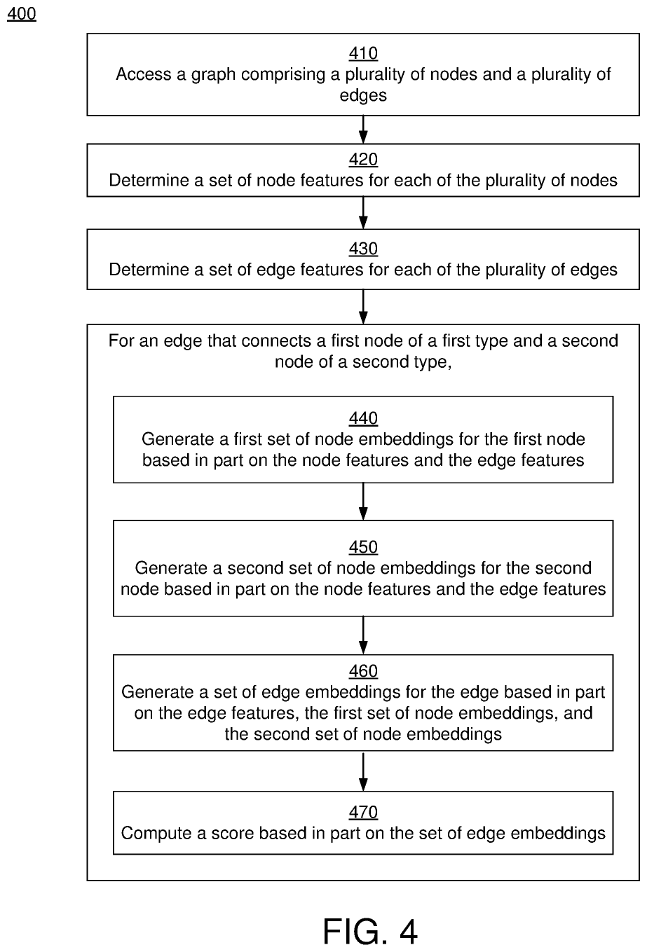

FIG. 4 is a flowchart of an example method 400 of predicting a likelihood of an occurrence of a transaction between nodes in a graph, in accordance with one or more embodiments. In various embodiments, the method includes different or additional steps than those described in conjunction with FIG. 4. Further, in some embodiments, the steps of the method may be performed in different orders than the order described in conjunction with FIG. 4. The method described in conjunction with FIG. 4 may be carried out by system 200 in various embodiments, while in other embodiments, the steps of the method are performed by any computer system capable of accessing a pre-trained neural network.

The system 200 accesses 410 a graph (e.g., graph 100) comprising a plurality of nodes and a plurality of edges linking the plurality of nodes. The plurality of nodes include a first type of nodes representing a first type of entities and a second type of nodes representing a second type of entities.

The system 200 extracts 420 a set of node features for each of the plurality of nodes based on information related to the node. The system 200 also extracts 430 a set of edge features for each of the plurality of nodes based on information related to the edges.

For an edge that connects a first node of the first type and a second node of the second type, the system 200 generates 440 a first set of node embeddings for the first node based in part on the set of node features and the set of edge features. Similarly, the system generates 450 a second set of node embeddings for the second node based in part on the set of node features and the set of edge features. In some embodiments, the first set of node embeddings are generated based in part on node features and edge features associated with nodes and/or edges that are within a neighborhood of the first node; the second set of node embeddings are generated based in part on nodes features and edge features associated with nodes and edges that are within a neighborhood of the second node. In some embodiments, the generation of the first set and second set of node features are performed based on Equations (1)-(5)/or and (7) described above with respect to FIGS. 3A-3B.

The system 200 also generates 460 a set of edge embeddings for the edge based in part on the first set of node embeddings, the second set of node embeddings, and the set of edge features. In some embodiments, the generation of the set of edge embeddings is performed based on Equations (6) and (8) described above with respect to FIGS. 3A-3B.

The system 200 computes 470 a score based in part on the set of edge embeddings. The score indicates a likelihood of an occurrence of a transaction between the first node and the second node. In some embodiments, the system 200 sets a threshold score. Responsive to determining that the score is greater than a threshold, the system 200 determines that the transaction between the first node and the second node is likely to occur. In some embodiments, the score is computed by a machine learning network, such as machine learning network 300D of FIG. 3D. In some embodiments, responsive to determining that the transaction is likely to occur, the system 200 generates and sends a notification to an entity associated with the first node or the second node.

For example, the first type of entities is salespersons, and the second type of entities is leads. The first node is associated with a salesperson, and the second node is associated with a lead. The edge represents a relationship or transaction between the salesperson and the lead. The score indicates a likelihood of the lead being converted into a customer by the salesperson. Responsive to determining that the lead is likely to be converted to a customer by the salesperson, the system 200 generates a notification to the salesperson, and/or prioritize the customer to have a higher priority. On the other hand, responsive to determining that the lead is not likely to be converted, the system 200 may automatically prioritize the customer to have a lower priority. Note, the same customer may be more or less likely to be converted by a second salesperson. In that case, the system 200 may generate a notification to a salesperson that has a highest score, or add that lead to that salesperson's queue, such that the lead is to be handled by that the salesperson that is most likely to conver the lead to a customer

As another example, the first type of entities is merchants, and the second type of entities is customers. The first node is associated with a merchant, and the second node is associated with a customer. The edge linking the first node and the second node represents a relationship or transaction between the merchant and the customer. The score indicates a likelihood of a completion of a purchase transaction between the merchant and the customer, through which the customer purchases a good or a service from the merchant.

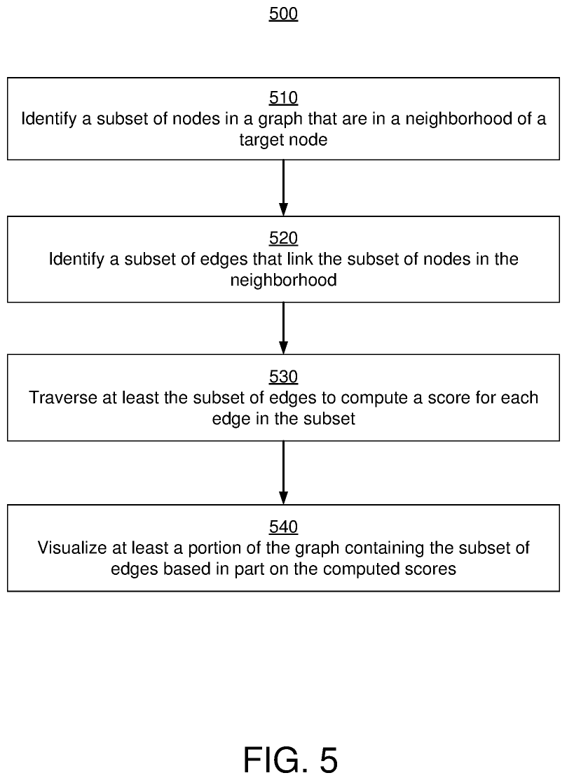

In some embodiments, the system 200 is also configured to visualize a graph or a subgraph based on scores associated with the edges. FIG. 5 is a flowchart of an example method 500 of visualizing a graph, in accordance with one or more embodiments. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by system 200 in various embodiments, while in other embodiments, the steps of the method are performed by any computer system capable of accessing a pre-trained neural network.

The system 200 identifies 510 a subset of nodes in a graph that are in a neighborhood of a target node. The neighborhood of the target node may be defined based on a maximum number of edges between the target node and another node. For example, if a maximum number of edges is 2, the nodes that are within 2 edges from the target node (i.e., one or two edges) are identified as in the neighborhood. The system 200 identifies 520 a subset of edges that link the subset of nodes in the neighborhood. After or during identifying the subset of nodes, the subset edges that link the subset of nodes can also be identified.

The system 200 traverses 530 at least the subset of edges to compute a score for each edge in the subset. Traversing 530 the subset of edges includes for each edge in the subset, the system 200 computes a score, indicating a likelihood of an occurrence of a transaction between two nodes linked by the edge. This process may be performed based on steps 440-470 in FIG. 4. Traversing 530 the subset of edges will result in multiple scores, each of which corresponds to an edge in the subset of edges.

The system 200 visualizes 540 at least a portion of the graph containing the subset of edges based in part on the computed scores. For example, the visualization may show multiple nodes connected with lines, which represent the edges. In some embodiments, different scores may correspond to different colored or formatted lines representing edges. In some embodiments, the edges that correspond to scores lower than a threshold are presented as a first color or first format (e.g., dotted line), and the edges that correspond to scores higher than the threshold are presented as a second color or second format (e.g., solid line). For example, in some embodiments, the visualization may be in a format similar to the graph shown in FIG. 1.

In some embodiments, the edges or corresponding nodes that correspond to scores lower than a threshold are omitted. For example, the target node may correspond to a salesperson. The scores corresponding to the edges represent a likelihood of a lead being converted to a customer by the salesperson. In some embodiments, the likelihood is lower than a threshold score, and the node corresponding to that customer and the edge linking to the lead may be omitted. Alternatively or in addition, the salesperson can set a threshold score, or a maximum number of leads that the salesperson can handle. The system can generate to show a subset of the leads based on the scores of the edges, the threshold score, and/or the maximum number of leads that the salesperson can handle. In some embodiments, the subset of the leads may be presented as a subgraph, a table, a list, and/or a combination thereof.

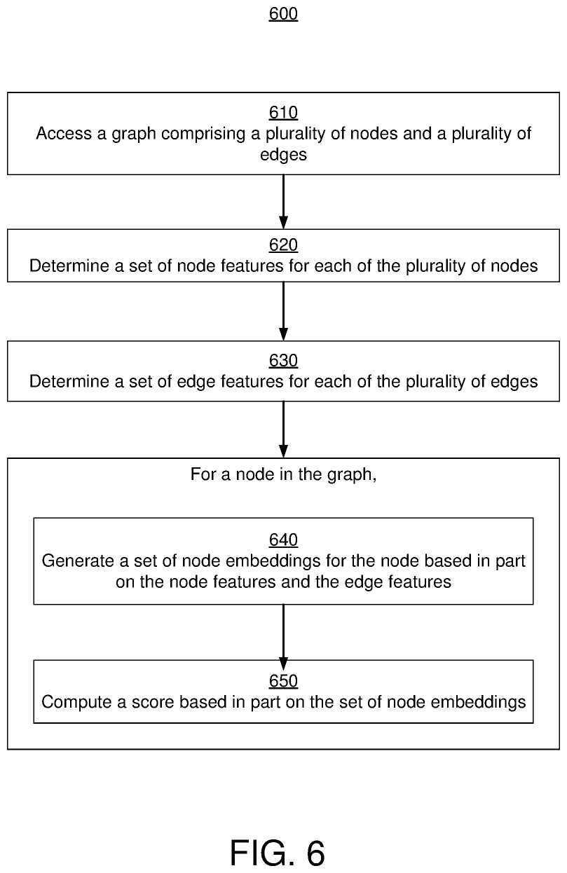

In some embodiments, the system 200 is also able to classify a node in a graph based in part on information related to related nodes and edges in the graph. FIG. 6 is a flowchart of an example method 600 of classifying a node in a graph, in accordance with one or more embodiments. In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by system 200 in various embodiments, while in other embodiments, the steps of the method are performed by any computer system capable of accessing a pre-trained neural network.

Similar to method 400, the system 200 accesses 610 a graph comprising a plurality of nodes and a plurality of edges. The plurality of nodes include a first type of nodes representing a first type of entities and a second type of nodes representing a second type of entities. The system 200 extracts 620 a set of node features for each of the plurality of nodes, and extracts 630 a set of edge features for each of the plurality of edges.

For a node in the graph, the system 200 generates 640 a set of node embeddings for the node based in part on the node features and the edge features. In some embodiments, the set of node embeddings are generated based on node features and edge features of nodes within a neighborhood of the node. In some embodiments, the generation of the set of node features are performed based on Equations (1)-(5) and/or (7) described above with respect to FIGS. 3A-3B. The system 200 then computes 650 a score based in part on the set of node embeddings. The score classifies the node into a classification. Notably, because the set of node embeddings for the node is generated based on node and edge features of nearby nodes and edges, the score for the node is generated based in part on interactions of the node with other nodes.

For example, the first type of entities are merchant, and the second type of entities are customers. The score for a node corresponding to a merchant or a customer may indicate a likelihood of the merchant or the customer being fraudulent.

In some embodiments, the system 200 may also visualize the graph based on the scores generated for different nodes. For example, for a given node corresponding to a customer, the system 200 may visualize all the nearby merchants based on their fraudulent scores. Alternatively, or in addition, responsive to detecting a nearby merchant is likely to be fraudulent, the system 200 may generate a notification, alerting the customer. Alternatively or in addition, before a transaction between a customer and the merchant is completed, the system 200 may determine that the merchant is likely fraudulent, and prevent the transaction from going through.

### Computer Architecture

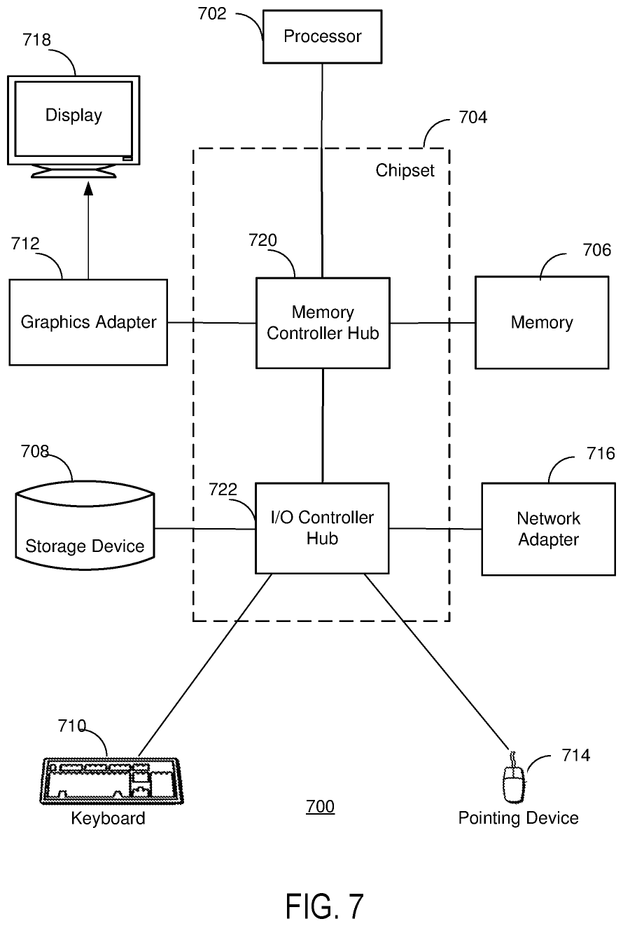

FIG. 7 is a block diagram illustrating the architecture of a typical computer system 700 for use in the machine learning system 200 of FIG. 2 according to one embodiment. Illustrated are at least one processor 702 coupled to a chipset 704. Also coupled to the chipset 704 are a memory 706, a storage device 708, a keyboard 710, a graphics adapter 712, a pointing device 714, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is a non-transitory computer-readable storage medium, such as a hard drive, compact disk read-only memory (CD-ROM), DVD, or a solid-state memory device. The memory 706 holds instructions and data used by the processor 702. The pointing device 714 may be a mouse, track ball, or other type of pointing device, and is used in combination with the keyboard 710 to input data into the computer system 700. The graphics adapter 712 displays images and other information on the display 718. The network adapter 716 couples the computer system 700 to a network.

As is known in the art, a computer system 700 can have different and/or other components than those shown in FIG. 7. In addition, the computer system 700 can lack certain illustrated components. For example, a computer system 700 acting as an system 200 may lack a keyboard 710 and a pointing device 714. Moreover, the storage device 708 can be local and/or remote from the computer system 700 (such as embodied within a storage area network (SAN)).

The computer system 700 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 708, loaded into the memory 706, and executed by the processor 702.

The types of computer systems 700 used by the system of FIG. 2 can vary depending upon the embodiment and the processing power used by the entity. For example, a client device may be a mobile phone with limited processing power, a small display 718, and may lack a pointing device 714. The system 200 in contrast, may comprise multiple blade servers working together to provide the functionality described herein.

### Additional Considerations

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real-time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes and may not have been selected to delineate or circumscribe the inventive subject matter. Accordingly, the disclosure of the embodiments is intended to be illustrative, but not limiting.

We claim:

1. A computer-implemented method, the method comprising:
accessing a graph comprising a plurality of nodes and a plurality of edges linking the plurality of nodes, the plurality of nodes comprising a first type of nodes representing a first type of entities and a second type of nodes representing a second type of entities;
extracting a set of node features for each of the plurality of nodes;
extracting a set of edge features for each of the plurality of edges;
for an edge that connects a first node of the first type and a second node of the second type,
generating (1) a first set of node embeddings for the first node and (2) a second set of node embeddings for the second node based in part on the set of node features and the set of edge features;
generating a set of edge embeddings for the edge based in part on the first set of node embeddings, the second set of node embeddings, and the set of edge features; and
computing a score based in part on the set of edge embeddings, the score indicating a likelihood of an occurrence of a transaction between the first node and the second node.

2. The computer-implemented method of claim 1, wherein the method further comprises:
responsive to determining that the score is greater than a threshold,
determining that the transaction between the first node and the second node is likely to occur; and
generating and sending a notification to an entity associated with the first node or the second node.

3. The computer-implemented method of claim 1, wherein the method further comprises:
traversing at least a subset of edges of the graph to compute a score for each edge in the subset; and
visualizing at least a portion of the graph containing the subset of edges based in part on the computed scores.

4. The computer-implemented method of claim 3, wherein the method further comprises:
identifying a subset of nodes that is within a neighborhood of a target node; and
identifying the subset of edges that link the subset of nodes within the neighborhood.

5. The computer-implemented method of claim 4, wherein the first type of nodes represents salespersons, the second type of nodes represents leads, and the transaction between the first node and the second node is a conversion of a lead into a customer.

6. The computer-implemented method of claim 4, wherein the subset of edges is within a neighborhood of the first node corresponding to a particular salesperson, and the subset of edges are visualized and presented to client device of the particular salesperson.

7. The computer-implemented method of claim 4, wherein the first type of nodes represents merchants, the second type of nodes represents customers, and the transaction between the first node and the second node is a purchase transaction that a customer corresponding to the second node purchases a good or service from a merchant corresponding to the first node.

8. The computer-implemented method of claim 4, wherein the subset of edges is within a neighborhood of the first node corresponding to a particular merchant, and the subset of edges are visualized and presented to client device of the particular merchant.

9. The computer-implemented method of claim 1, wherein the method further comprising:
accessing a neural network model trained over data associated with the graph, wherein the neural network is trained to:
receive the set of node features and the set of edge features to generate the first set of node embeddings for the first node, the second set of node embeddings for the second node, and the edge embeddings for the edge; and
computing the score based in part on the set of edge embeddings.

10. A non-transitory computer-readable medium, stored thereon computer-executable instructions, that when executed by a processor of a computer system, cause the computer system to:
access a graph comprising a plurality of nodes and a plurality of edges linking the plurality of nodes, the plurality of nodes comprising a first type of nodes representing a first type of entities and a second type of nodes representing a second type of entities;
extract a set of node features for each of the plurality of nodes;
extract a set of edge features for each of the plurality of edges;
for an edge that connects a first node of the first type and a second node of the second type,
generate (1) a first set of node embeddings for the first node and (2) a second set of node embeddings for the second node based in part on the set of node features and the set of edge features;
generate a set of edge embeddings for the edge based in part on the first set of node embeddings, the second set of node embeddings, and the set of edge features; and
compute a score based in part on the set of edge embeddings, the score indicating a likelihood of an occurrence of a transaction between the first node and the second node.

11. The non-transitory computer-readable medium of claim 10, stored thereon additional computer-executable instructions, that when executed by the processor of the computer system, cause the computer system to:
responsive to determining that the score is greater than a threshold,
determine that the transaction between the first node and the second node is likely to occur; and
generate and send a notification to an entity associated with the first node or the second node.

12. The non-transitory computer-readable medium of claim 10, stored thereon additional computer-executable instructions, that when executed by the processor of the computer system, cause the computer system to:
traverse at least a subset of edges of the graph to compute a score for each edge in the subset; and
visualize at least a portion of the graph containing the subset of edges based in part on the computed scores.

13. The non-transitory computer-readable medium of claim 12, wherein the subset of edges is within a neighborhood of a particular node.

14. The non-transitory computer-readable medium of claim 13, wherein the first type of nodes represents salespersons, the second type of nodes represents leads, and the transaction between the first node and the second node is a conversion of a lead into a customer.

15. The non-transitory computer-readable medium of claim 13, wherein the subset of edges is within a neighborhood of the first node corresponding to a particular salesperson, and the subset of edges are visualized and presented to client device of the particular salesperson.

16. The non-transitory computer-readable medium of claim 13, wherein the first type of nodes represents merchants, the second type of nodes represents customers, and the transaction between the first node and the second node is a purchase transaction that a customer corresponding to the second node purchases a good or service from a merchant corresponding to the first node.

17. The non-transitory computer-readable medium of claim 13, wherein the subset of edges is within a neighborhood of the first node corresponding to a particular merchant, and the subset of edges are visualized and presented to client device of the particular merchant.

18. The non-transitory computer-readable medium of claim 10, stored thereon additional computer-executable instructions, that when executed by the processor of the computer system, cause the computer system to:
access a neural network model trained over data associated with the graph, wherein the neural network is trained to:
receive the set of node features and the set of edge features to generate the first set of node embeddings for the first node, the second set of node embeddings for the second node, and the edge embeddings for the edge; and
computing the score based in part on the set of edge embeddings.

19. A computer system comprising:
a processor; and
a non-transitory computer readable storage medium, stored thereon computer-executable instructions, that when executed by the processor, cause the processor to:
access a graph comprising a plurality of nodes and a plurality of edges linking the plurality of nodes, the plurality of nodes comprising a first type of nodes representing a first type of entities and a second type of nodes representing a second type of entities;
extract a set of node features for each of the plurality of nodes;
extract a set of edge features for each of the plurality of edges;
for an edge that connects a first node of the first type and a second node of the second type,
generate (1) a first set of node embeddings for the first node and (2) a second set of node embeddings for the second node based in part on the set of node features and the set of edge features;
generate a set of edge embeddings for the edge based in part on the first set of node embeddings, the second set of node embeddings, and the set of edge features; and
compute a score based in part on the set of edge embeddings, the score indicating a likelihood of an occurrence of a transaction between the first node and the second node.

20. The computer system of claim 19, wherein the non-transitory computer readable storage medium, stored thereon additional computer-executable instructions, that when executed by the processor of the computer system, cause the computer system to:
responsive to determining that the score is greater than a threshold,
determine that the transaction between the first node and the second node is likely to occur; and
generate and send a notification to an entity associated with the first node or the second node.
